(19) United States
(12) Patent Application Publication
(10) Pub. No.: US 2019/0039888 A1
(43) Pub. Date: Feb. 7, 2019

(54) DEVICE AND METHOD FOR HYDROGEN PRODUCTION WITH WASTE ALUMINUM, AND METHOD FOR HYDROGEN PRODUCTION WITH ALUMINUM

(71) Applicant: Chung Yuan Christian University, Taoyuan City (TW)

(72) Inventor: Ching-Yuan Ho, Taoyuan City (TW)

(73) Assignee: Chung Yuan Christian University, Taoyuan City (TW)

(21) Appl. No.: 15/828,262

(22) Filed: Nov. 30, 2017

(30) Foreign Application Priority Data
Aug. 7, 2017 (TW) 106126607

(51) Int. Cl. C01B 3/08; B01J 7/02; B01J 19/00; B22F 9/04; C22F 1/04; C23G 1/00

(52) U.S. Cl. CPC C01B 3/08; B01J 7/02; B01J 19/002; B22F 9/04; B01J 2219/00966; C23G 1/00; B01J 2219/00337; B01J 2219/00961; B01J 2219/00963; C22F 1/04

(57) ABSTRACT

A device for hydrogen production with waste aluminum includes a treatment apparatus for waste aluminum and a reaction tank. The apparatus includes a first crusher, a pickling tank, and a second crusher. The first crusher is for preliminarily crushing waste aluminum to obtain first aluminum chips. The pickling tank is for receiving and pickling the first aluminum chips crushed by the first crusher. The second crusher is for receiving and fine crushing the first aluminum chips to obtain second aluminum chips. The second aluminum chips are received by the reaction tank and then hydrolyzed with an alkaline solution in the reaction tank to produce hydrogen. Since waste aluminum is used as the raw material of hydrogen production, and a specific device is used for waste aluminum treatment, so the effects of recovering waste metal, reducing environmental damage, and saving costs can be achieved at the same time.

### CROSS-REFERENCE TO RELATED APPLICATION

This application claims the priority benefit of Taiwan application no. 106126607 filed on Aug. 7, 2017. The entirety of the above-mentioned patent application is hereby incorporated by reference herein and made a part of this specification.

### BACKGROUND OF THE INVENTION

### Field of the Invention

The invention relates to a hydrogen production technique, and more particularly, to a device and a method for hydrogen production with waste aluminum, and a method for hydrogen production with aluminum.

### Description of Related Art

Hydrogen can be applied in the synthesis of chemical substances such as methanol and ammonia, and is the main raw material of many organic chemical industries; hydrogen can also be applied in the petrochemical industry to clean external phenol and pyridine. In the aerospace industry, hydrogen is used in large amounts as propellant fuel for spaceships and rockets; and in emerging industries, hydrogen also acts as fuel for fuel cells and hydrogen internal combustion engines to convert chemical energy into power to achieve the effect of green energy.

However, since the current method for hydrogen production with fossil fuel is not environmentally friendly. Other advanced hydrogen production techniques (such as hydrogen production with electrolyzed water) has a higher threshold, and cost and equipment thereof are both more expensive, and thus related industries still cannot achieve hydrogen production on the commercial scale with economic benefits.

### SUMMARY OF THE INVENTION

The invention provides a device for hydrogen production with waste aluminum suitable for efficient and environmentally-friendly hydrogen production techniques.

The invention provides a method for hydrogen production with waste aluminum that produces hydrogen with reduced environmental damage and lower costs.

The invention provides a method for hydrogen production with aluminum that can increase hydrogen production efficiency.

The device for hydrogen production with waste aluminum of the invention includes a treatment apparatus for waste aluminum and a reaction tank. The treatment apparatus for waste aluminum at least includes a first crusher, a pickling tank, and a second crusher. The first crusher is for preliminarily crushing waste aluminum to obtain first aluminum chips. The pickling tank is for receiving and pickling the first aluminum chips crushed by the first crusher. The second crusher is for receiving and performing a fine crushing on the first aluminum chips pickled by the pickling tank to obtain second aluminum chips. The reaction tank receives the second aluminum chips obtained from the treatment apparatus to hydrolyze the second aluminum chips with an alkaline solution in the reaction tank.

In an embodiment of the invention, the treatment apparatus for waste aluminum can further include a stamping device for receiving and stamping the second aluminum chips crushed by the second crusher.

In an embodiment of the invention, an anti-corrosion layer is further disposed on the inner surface of the reaction tank.

In an embodiment of the invention, the anti-corrosion layer includes graphene or a graphene oxide coating.

In an embodiment of the invention, the device for hydrogen production with waste aluminum can further include a gas valve and a liquid valve. The gas valve is connected to the reaction tank and a gas collection tube for controlling gas entry and hydrogen discharge. The liquid valve is connected to the bottom of the reaction tank to control solution drain after the hydrolysis reaction.

In an embodiment of the invention, the device for hydrogen production with waste aluminum can further include a pressure sensor, a temperature sensor, a pH sensor, a controller, and a heating device. The pressure sensor is for sensing the gas pressure in the reaction tank; the temperature sensor is for sensing the temperature of the alkaline solution in the reaction tank; the pH sensor is for sensing the pH value of the alkaline solution in the reaction tank; the controller respectively receives data of the pressure, temperature, and pH sensors to monitor gas pressure, temperature, and pH value in the reaction tank. The heating device is connected to the controller to be controlled by the controller to increase the temperature in the reaction tank to a specified temperature.

The method for hydrogen production with waste aluminum of the invention includes performing preliminary crushing on waste aluminum using a first crusher to obtain first aluminum chips, then pickling the first aluminum chips, and then performing fine crushing on the pickled first aluminum chips using a second crusher to obtain second aluminum chips. Next, a hydrolysis reaction is performed on the second aluminum chips and an alkaline solution to produce hydrogen.

In another embodiment of the invention, the size of each of the second aluminum chips is 100 μm to 1 mm.

In another embodiment of the invention, the size of each of the first aluminum chips is less than 5 cm.

In another embodiment of the invention, before the hydrolysis reaction is performed, stamping can be further performed to produce cracks on the surface of each of the second aluminum chips to increase the surface area thereof.

In another embodiment of the invention, the alkaline solution includes sodium hydroxide or sodium borohydride (NaBH₄).

In another embodiment of the invention, the concentration of the sodium hydroxide is between 0.25 M and 0.5 M.

In another embodiment of the invention, the temperature of the hydrolysis reaction is between 40° C. and 70° C.

In another embodiment of the invention, before the preliminary crushing, waste aluminum can be further cleaned using clear water.

In another embodiment of the invention, before the fine crushing, the pickled first aluminum chips can be further cleaned using clean water.

The method for hydrogen production with aluminum of the invention includes performing a hydrolysis reaction on raw aluminum with a sodium borohydride aqueous solution to produce hydrogen.

In yet another embodiment of the invention, the raw aluminum includes waste aluminum, aluminum powder, or nano-aluminum.

In yet another embodiment of the invention, the waste aluminum is aluminum chips having a size of 100 μm to 1 mm.

In yet another embodiment of the invention, the temperature of the hydrolysis reaction is between 40° C. and 70° C.

Based on the above, in the invention, by combining the principle of hydrolyzing waste aluminum metal in water with a specific treatment apparatus for waste aluminum, waste aluminum metal can be recycled and hydrogen production efficiency can be increased at the same time. Moreover, environmental damage can be reduced and costs can be lowered. In the invention, since a safe and efficient method for hydrogen production can be provided, the hydrogen produced can be applied in various fields, and therefore in the world trend of emerging hydrogen green energy, the invention has considerable commercial potential.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of a device for hydrogen production with waste aluminum according to the first embodiment of the invention.

FIG. 2 is a schematic of a variation of the device for hydrogen production with waste aluminum in the first embodiment.

FIG. 3 is a flowchart of hydrogen production with waste aluminum according to the second embodiment of the invention.

FIG. 4 is a graph of hydrogen production efficiency of example 1 and comparative example 2.

### DESCRIPTION OF THE EMBODIMENTS

Hereinafter, the concepts of the invention are described in more detail with reference to figures and their embodiments. However, in addition to the embodiments in the specification, the invention can also be implemented in various different forms, and should not limited to the embodiments provided. In the figures, each figure shows the general features of the structure, material, and/or device in the embodiments, and the figures act as a supplement to the text descriptions provided below and should not be construed as defining or limiting the scope or nature of the values of the embodiments. For instance, for clarity, the relative thicknesses and locations of films layers, regions, and/or structures may be reduced or enlarged. Moreover, similar or the same reference numerals are used in each figure to represent similar or the same elements.

Moreover, in the specification, when a device is “connected” or “coupled” to another device, the device can be directly connected or coupled to the other device, or an intermediate device can be present. On the other hand, when the device is “directly connected” or “directly coupled” to another device, an intermediate device is not present.

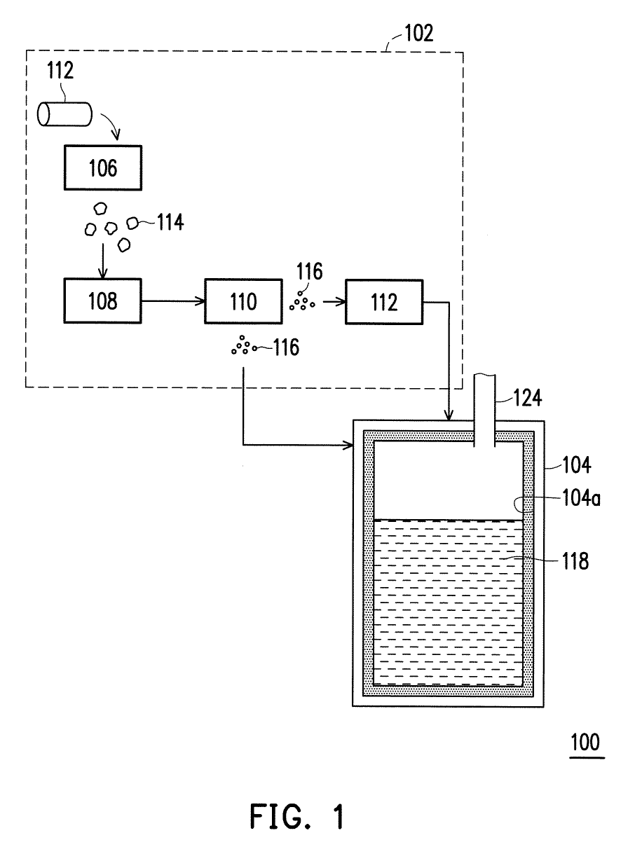

FIG. 1 is a schematic of a device for hydrogen production with waste aluminum according to the first embodiment of the invention.

Referring to FIG. 1, a device 100 for hydrogen production with waste aluminum of the first embodiment at least includes a treatment apparatus 102 for waste aluminum and a reaction tank 104. The treatment apparatus 102 for waste aluminum at least includes a first crusher 106, a pickling tank 108, and a second crusher 110. The first crusher 110 is for preliminarily crushing a waste aluminum 112 to obtain first aluminum chips 114. Moreover, the first aluminum chips 114 can be moved from the first crusher 110 to the pickling tank 108 by a delivery tool (not shown) such as a conveyor belt for pickling. Next, the first aluminum chips 114 pickled by the pickling tank 108 can similarly be moved from the pickling tank 108 to the second crusher 110 by a delivery tool (not shown) such as a conveyor belt to perform fine crushing and obtain second aluminum chips 116. The reaction tank 104 receives the second aluminum chips 116 obtained from the treatment apparatus 102 for waste aluminum and hydrolyze the second aluminum chips 116 with an alkaline solution 118 in the reaction tank 104. In an embodiment, an anti-corrosion layer 120 is further disposed on an inner surface 104a of the reaction tank 104 for preventing corrosion to the reaction tank 104 itself from the alkaline solution 118. In an embodiment, the source of the anti-corrosion layer 120 can be a regular anti-corrosion paint coated on the inner surface 104a of the reaction tank 104. In another embodiment, the anti-corrosion layer 120 is, for instance, graphene or a graphene oxide coating. If the anti-corrosion layer 120 is graphene, then graphene can be deposited on the inner surface 104a of the reaction tank 104 by chemical vapor deposition (CVD); if the anti-corrosion layer 120 is a graphene oxide coating, then a graphene oxide coating can be made by an improved Hummers method and then coated on the inner surface 104a of the reaction tank 104. The improved Hummers method includes, for instance, placing sodium nitrate and graphite in sulfuric acid and performing a preliminary oxidation on the graphite by stirring at a specific temperature, and then adding a fixed quantity of potassium permanganate followed by sufficiently oxidizing at the three stages of low temperature, medium temperature, and high temperature. Thereafter, the mixture is put in hydrogen peroxide for pickling with dilute hydrochloric acid; after dialysis, a neutral oxide graphene coating is obtained.

In an embodiment, in the improved Hummers method, the graphite powder has a size of <20 μm and a weight of about 2 g; the sodium nitrate has a weight of about 1 g; the sulfuric acid has a concentration of about 95% to 97% (volume of 80 mL); the potassium permanganate has a weight of about 8 g; the low temperature is 0° C. to 5° C., the medium temperature is 40° C., and the high temperature is 98° C.; the hydrogen peroxide has a concentration of about 35% (volume of 30 mL); the hydrochloric acid has a concentration of about 5% (volume of 30 mL); and the MWCO (molecular weight cutoff) is 6,000 to 8,000, and the dialysis time is one week.

In FIG. 1, the treatment apparatus 102 for waste aluminum can further include a stamping device 122 for receiving and stamping the second aluminum chips 116 crushed by the second crusher 110 to further increase the reaction area of the surface of the second aluminum chips 116, and then hydrolysis is performed in the reaction tank 104 for hydrogen production. The resulting hydrogen can be discharged from a gas collection tube 124 and transported to a gas collection device (not shown).

Since the raw material of hydrogen production in the first embodiment is recycled waste aluminum (such as aluminum can) and no other catalysts or alloys need to be added in the hydrogen production process, the hydrogen production process has a hydrogen production efficiency comparable to that of commercial scale hydrogen production, and therefore costs can be significantly reduced and the hydrogen production process can become a more environmentally friendly hydrogen production technique.

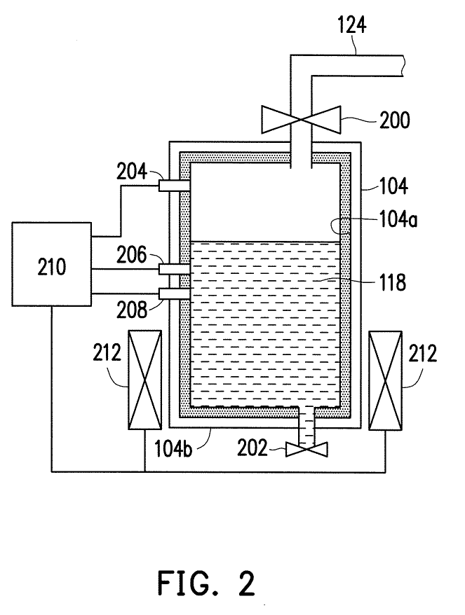

FIG. 2 is a schematic of a variation of the device for hydrogen production with waste aluminum in the first embodiment. For clarity, the treatment apparatus for waste aluminum is only represented by a reference numeral, and detailed description thereof is omitted.

Referring to FIG. 2, the device 102 for hydrogen production with waste aluminum of the first embodiment can further include a gas valve 200 and a liquid valve 202. The gas valve 200 is connected to the reaction tank 104 and the gas collection tube 124 for controlling gas entry and hydrogen discharge. The liquid valve 202 can be connected to a bottom 104b of the reaction tank 104 to control solution drain after the hydrolysis reaction. In FIG. 2, the device 100 for hydrogen production with waste aluminum can further include a pressure sensor 204, a temperature sensor 206, a pH sensor 208, a controller 210, and a heating device 212. The pressure sensor 204 is for sensing the gas pressure in the reaction tank 104; the temperature sensor 206 is for sensing the temperature of the alkaline solution 118 in the reaction tank 104; the pH sensor 208 is for sensing the pH value of the alkaline solution 118 in the reaction tank 104; and the controller 210 respectively receives data of the pressure, temperature, and pH sensors 204, 206, and 208 to monitor gas pressure, temperature, and pH value in the reaction tank 104. The heating device 212 is connected to the controller 210 to be controlled by the controller 210 to increase the temperature in the reaction tank 104 to a specified temperature. When the temperature in the reaction tank 104 reaches the specified temperature, heating can be stopped or a fixed heating power can be maintained to keep the temperature in the reaction tank 104 until the end of the (hydrogen production by hydrolysis) reaction.

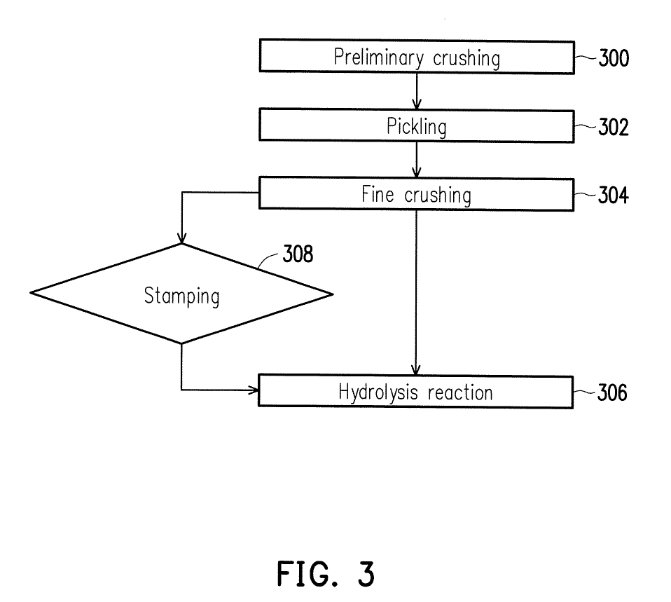

FIG. 3 is a flowchart of hydrogen production with waste aluminum according to the second embodiment of the invention.

Referring to FIG. 3, in step 300, preliminary crushing is performed on waste aluminum using a first crusher to obtain first aluminum chips, wherein the size of each of the first aluminum chips is less than 5 cm and the surface area thereof is, for instance, 1 cm² to 2 cm². In the second embodiment, before step 300, waste aluminum can be cleaned using clean water, wherein the clean water is, for instance, treated deionized water.

Next, in step 302, the first aluminum chips are pickled. For instance, non-aluminum substances such as paint and films on the surface of the first aluminum chips are removed by concentrated sulfuric acid. The concentration of the concentrated sulfuric acid is, for instance, 95% to 97%.

Next, in step 304, fine crushing is performed on the pickled first aluminum chips using a second crusher to obtain second aluminum chips, wherein the size of each of the second aluminum chips is 100 μm to 1 mm, and the surface area thereof is, for instance, about 0.5 cm². Before the hydrolysis reaction is performed, stamping can be performed (step 308) to produce cracks on the surface of the second aluminum chips to increase the surface area thereof. In the second embodiment, before step 304, the pickled first aluminum chips can be cleaned using clean water, and the number of cleaning can be increased as needed, wherein the clean water is, for instance, treated deionized water.

Next, in step 306, the second aluminum chips are hydrolyzed with the alkaline solution to produce hydrogen. The alkaline solution is, for instance, sodium hydroxide or sodium borohydride (NaBH₄). If the alkaline solution is sodium hydroxide, then the concentration is, for example, between 0.25 M and 0.5 M. The temperature of the hydrolysis reaction can be controlled between 40° C. and 70° C., for example. If the temperature, pressure, and pH of the hydrolysis reaction are suitably controlled, then hydrolysis can be performed more rapidly to produce high-purity hydrogen.

In other embodiments, the invention provides a method for hydrogen production with aluminum including hydrolyzing raw aluminum and a sodium borohydride aqueous solution to produce hydrogen. The temperature of the hydrolysis reaction is, for instance, controlled between 40° C. and 70° C. Since no other catalysts or alloys need to be added in the hydrogen production process of the present embodiment and only sodium borohydride and water are needed, hydrogen can be produced from the hydrolysis reaction of aluminum, such that the hydrogen production process has a hydrogen production efficiency comparable to that of commercial scale hydrogen production, and has an efficiency greater than hydrogen production by hydrolyzing sodium hydroxide by two times or more.

In the method for hydrogen production with aluminum according to an embodiment of the invention, the raw aluminum is, for instance, waste aluminum, aluminum powder, or nano-aluminum, wherein the aluminum powder or nano-aluminum both refer to commercial products. If waste aluminum is used as raw aluminum, the waste aluminum can be aluminum chips having a size of 100 μm to 1 mm, and a waste aluminum treatment can be performed by the device of the first embodiment with reference to step 300 to step 304 (and step 308) of the second embodiment.

In general, although the efficiency of using aluminum powder or nano-aluminum to produce hydrogen is good, significant raw material cost is needed; the use of waste aluminum can significantly reduce costs, and when combined with the waste aluminum treatment technique of the first and second embodiments of the invention, the efficiency of hydrogen production with waste aluminum is comparable to that of commercial scale hydrogen production.

Several experimental examples are described below to verify the efficacy of the invention. However, the invention is not limited to the following content.

### Experimental Example 1

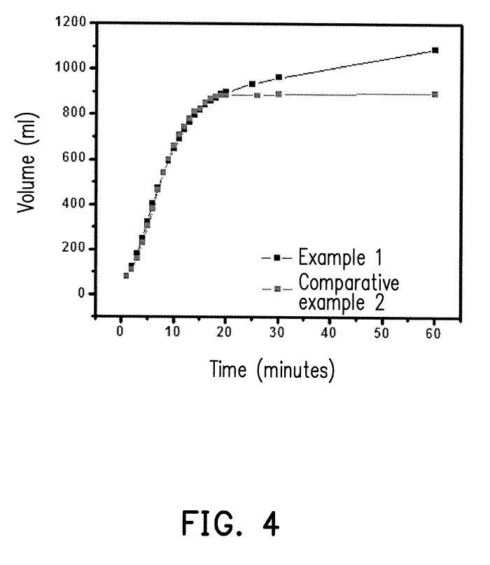

After an aluminum can was preliminarily crushed by a crusher, the size of each of the aluminum chips was about 1 cm, and then the aluminum chips were placed in concentrated sulfuric acid and glazed for about 30 minutes and then cleaned using deionized water. The air-dried aluminum chips were placed in the crusher again for fine crushing, and the size of each of the aluminum chips after fine crushing was about 0.5 cm or less. 1 g of the treated aluminum chips and 50 mL of sodium hydroxide were placed in 0.5 M of an aqueous solution to produce hydrogen at 70° C. The resulting data is shown in FIG. 4.

### Comparative Example 1

After an aluminum can was cut into chips, the size of the aluminum chips was about 0.5 cm×0.5 cm, and the aluminum chips were placed in concentrated sulfuric acid to be pickled for 30 minutes then rinsed with deionized water and air dried, and then the aluminum can chips were placed in deionized water to produce hydrogen. Hydrogen production was very low, and not even 10 mL was produced in 1 day.

### Comparative Example 2

An aluminum can was cut into aluminum chips having a size of about 0.5 cm×0.5 cm, and then the aluminum chips were placed in concentrated sulfuric acid to be pickled for 30 minutes and then rinsed with deionized water and air dried. Next, the aluminum chips and sodium chloride were placed in a roller mill can for roller milling at 300 rpm for 24 hours. 1 g of the roller milled aluminum chips and 50 mL of sodium hydroxide were placed in 0.5 M of an aqueous solution to produce hydrogen at 70° C. The resulting data is shown in FIG. 4.

It can be learned from FIG. 4 that, based on the method for hydrogen production of experimental example 1, the efficiency thereof is increased with time, but the method of comparative example 1 shows stagnant hydrogen production efficiency after 20 minutes.

### Experimental Example 2

Hydrogen production was performed using the same preparation process as experimental example 1, but sodium hydroxide thereof was replaced with sodium borohydride (NaBH₄), and the concentration of NaBH₄ was 4.6 wt %.

Based on the above, in the invention, the actions of hydrogen production and collection are performed using a specific device based on the principle of hydrolyzing waste aluminum in water to simultaneously recycle waste metal, reduce environmental damage, and lower costs. Byproducts of the hydrolysis also play a part in the fire protection industry and ink industry applications. The overall hydrogen production process is more environmental friendly than hydrogen production with fossil fuel, and is more advantageous than hydrogen production with electrolyzed water in terms of cost. Since the invention provides a safe and efficient method for hydrogen production, the resulting hydrogen can be applied in numerous industry fields, and in comparison to the gradually declining fuel economy, hydrogen economy shows great prospects, and therefore in the world trend of emerging hydrogen green energy, the invention has considerable commercial potential.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A device for hydrogen production with a waste aluminum, comprising:
a treatment apparatus for the waste aluminum, comprising:
a first crusher for preliminarily crushing the waste aluminum to obtain first aluminum chips;
a pickling tank for receiving and pickling the first aluminum chips crushed by the first crusher; and
a second crusher for receiving and performing a fine crushing on the first aluminum chips pickled by the pickling tank to obtain second aluminum chips; and
a reaction tank for receiving the second aluminum chips obtained from the treatment apparatus to hydrolyze the second aluminum chips with an alkaline solution in the reaction tank.

2. The device for hydrogen production with the waste aluminum of claim 1, wherein the treatment apparatus for the waste aluminum further comprises a stamping device for receiving and stamping the second aluminum chips crushed by the second crusher.

3. The device for hydrogen production with the waste aluminum of claim 1, further comprises an anti-corrosion layer is disposed on an inner surface of the reaction tank.

4. The device for hydrogen production with the waste aluminum of claim 3, wherein the anti-corrosion layer comprises a graphene or a graphene oxide coating.

5. The device for hydrogen production with the waste aluminum of claim 1, further comprising:
a gas valve connected to the reaction tank and a gas collection tube for controlling a gas entry and a hydrogen discharge; and
a liquid value connected to a bottom of the reaction tank to control a solution drain after the hydrolysis reaction.

6. The device for hydrogen production with the waste aluminum of claim 1, further comprising:
a pressure sensor for sensing a gas pressure in the reaction tank;
a temperature sensor for sensing a temperature of the alkaline solution in the reaction tank;
a pH sensor for sensing a pH value of the alkaline solution in the reaction tank;
a controller respectively receiving data of the pressure sensor, the temperature sensor, and the pH sensor to monitor the gas pressure, the temperature, and the pH value in the reaction tank; and
a heating device connected to the controller to be controlled by the controller to increase the temperature in the reaction tank to a specified temperature.

7. A method for hydrogen production with a waste aluminum, comprising:
performing a preliminary crushing on the waste aluminum using a first crusher to obtain first aluminum chips;
pickling the first aluminum chips;
performing a fine crushing on the pickled first aluminum chips using a second crusher to obtain second aluminum chips; and
performing a hydrolysis reaction on the second aluminum chips with an alkaline solution to produce hydrogen.

8. The method for hydrogen production with the waste aluminum of claim 7, wherein a size of each of the second aluminum chips is 100 μm to 1 mm.

9. The method for hydrogen production with the waste aluminum of claim 7, wherein a size of each of the first aluminum chips is less than 5 cm.

10. The method for hydrogen production with the waste aluminum of claim 7, further comprising, before the hydrolysis reaction is performed, performing a stamping to produce cracks on a surface of each of the second aluminum chips to increase a surface area of each of the second aluminum chips.

11. The method for hydrogen production with the waste aluminum of claim 7, wherein the alkaline solution comprises a sodium hydroxide or a sodium borohydride.

12. The method for hydrogen production with the waste aluminum of claim 11, wherein a concentration of the sodium hydroxide is between 0.25 M and 0.5 M.

13. The method for hydrogen production with the waste aluminum of claim 11, wherein a temperature of the hydrolysis reaction is between 40° C. and 70° C.

14. The method for hydrogen production with the waste aluminum of claim 7, further comprising, before the preliminary crushing, cleaning the waste aluminum with a clean water.

15. The method for hydrogen production with the waste aluminum of claim 7, further comprising, before the fine crushing, cleaning the pickled first aluminum chips with a clean water.

16. A method for hydrogen production with an aluminum, comprising:
performing a hydrolysis reaction on a raw aluminum with a sodium borohydride aqueous solution to produce hydrogen.

17. The method for hydrogen production with the aluminum of claim 16, wherein the raw aluminum comprises a waste aluminum, an aluminum powder, or a nano-aluminum.

18. The method for hydrogen production with the aluminum of claim 17, wherein the waste aluminum is aluminum chips having a size of 100 μm to 1 mm.

19. The method for hydrogen production with the aluminum of claim 16, wherein a temperature of the hydrolysis reaction is between 40° C. and 70° C.
